(19) United States
(12) Patent Application Publication
(10) Pub. No.: US 2024/0308452 A1
(43) Pub. Date: Sep. 19, 2024

(54) Power Supply Management System for a Vehicle, Method for Operating the Power Management System and Computer Program Product for Carrying Out the Method

(71) Applicant: KNORR-BREMSE Systeme Für Nutzfahrzeuge GmbH, Muenchen (DE)

(72) Inventors: Huba NEMETH, Budapest (HU); Oliver JUNDT, Hessigheim (DE); Jens-Hauke MUELLER, Velbert-Neviges (DE)

(21) Appl. No.: 18/576,779

(22) PCT Filed: Jun. 24, 2022
(86) PCT No.: PCT/EP2022/067450

§ 371 Date: Jan. 5, 2024

(30) Foreign Application Priority Data
Jul. 12, 2021 (DE) 10 2021 207 374.3

(51) Int. Cl. B60R 16/03; B60R 16/023; G07C 5/08; H02J 3/38

(52) U.S. Cl. CPC B60R 16/03; B60R 16/0238; G07C 5/0808; H02J 3/38; H02J 2310/40

(57) ABSTRACT

A power supply management system for a vehicle includes at least one power supply system having at least one power supply unit, and at least one consumer system having at least two consumer units, each of which can be supplied with power via the power supply system. The at least two consumer units have, at least to some extent, the same range of functions.

### BACKGROUND AND SUMMARY

The present invention relates to a power supply management system for a vehicle, a method for operating the power management system and a computer program product for executing the method.

As a result of the increasing electrification of vehicles, multiple new vehicle components and vehicle architectures are employed. For example, pneumatic or hydraulic systems are entirely or partially replaced by electrical or electronic components or functional units. Moreover, new requirements have been generated by automated, or even autonomous driving applications, particularly with regard to safety-related functions. There is a consequent requirement for a reliable power supply management system for vehicles, such that the maintenance of a power supply, at least for functions which are required for the execution of a driving maneuver, can be ensured. This not only involves the supply of power in the form of electrical energy, but can also be applied in an equivalent manner to pneumatic, hydraulic or hybrid systems which are associated therewith or are independent therefrom.

For the enhancement of the secure maintenance of a sufficient power supply, specifically with respect to safety-related and safety-critical functions, electric power supply systems are known, particularly of a redundant design, which comprise both a primary power supply system and at least one supplementary power supply system. A consumer system which is connected to these supply units, even in the event of the loss of the primary power supply unit, can be maintained in service, at least in part, by means of the supplementary power supply unit.

For example, a consumer system comprises two consumer units having at least a partial redundancy in their functional scope, each of which can be supplied with power from a dedicated supplementary power supply system in the event of the loss of the primary power supply system. Accordingly, if one of the redundant supplementary power supply systems also fails, at least the consumer unit which is connected to the other supplementary power supply system can be maintained in service. However, any further failure of the still operable consumer unit will no longer be retrievable, such that the corresponding functional scope thereof will no longer be available. In the event of a resulting loss of safety-critical functions, vehicle occupants and other road users will be exposed to a substantial hazard, even if a stopping process is initiated in direct response thereto.

In particular, the consumer unit can comprise a control unit, a control device and/or an actuator of the vehicle.

In the light of the above-mentioned considerations, the object of the present invention is the provision of a power supply management system, a method for operating a power management system and a computer program for executing the method, by means of which the operational driving safety of a vehicle can be enhanced.

This object is achieved by a power supply management system for a vehicle, by a method for operating the power management system, and by a computer program product for executing the method according to the independent claims. Advantageous further developments of the invention are included in the dependent claims.

According to the invention, a power supply management system for a vehicle comprises at least one power supply system having at least one power supply unit, and at least one consumer system having at least two consumer units, each of which can be supplied with power by the power supply system, wherein the at least two consumer units assume an at least partially identical functional scope.

A consumer system can be, for example, a steering function system, a braking function system or a HAD (highly-automated driving) function system. The at least two consumer units thus respectively assume an at least partially identical functional scope, such that the at least two consumer units are mutually redundant vis-à-vis the at least partially identical functional scope. Correspondingly, the failure of one of the least two consumer units can be compensated by the other of the at least two consumer units, at least with respect to the same functional scope. This functional scope thus comprises both the availability of individual functions per se, such as a braking power function, and a characteristic feature of an individual function, for example the maximum power range of the braking function. The at least partially common functional scope can thus involve identical functional scopes, or can also relate to functionally equivalent functional scopes. Correspondingly, the at least partially common functional scopes do not focus on a scope of functions which is shared between the at least two consumer units, but also includes functional scopes which can be delivered redundantly, in an identical or functionally equivalent manner, in each of the consumer units.

The power supply system can comprise one or more power supply units, by means of which electric, pneumatic and/or hydraulic power can be delivered. Accordingly, a power supply unit can be, for example, a battery or a compressed air store for actuating a pneumatic braking actuator, as an element of a consumer system or a consumer unit. Consequently, the corresponding consumer system or the corresponding consumer unit is not restricted to an electronics unit or an electrically operated consumer unit but, alternatively or additionally, can also process pneumatic control signals. By means of different power supply units, the power supply system can also deliver a combination of types of power. The power supply system can additionally comprise further components, such as rectifiers or converters, for the conversion of power into an appropriate form for the take-up thereof by the at least one consumer unit, and/or coupling points for the interconnection of a plurality of power supply units. The supply of consumer units with corresponding power by the power supply system can be executed by means of a line connection of the consumer units to the power supply system, or to at least one of the power supply units of the power supply system. Accordingly, the line connection can be a direct connection of the consumer unit to at least one of the power supply units and/or an indirect connection via further components of the power supply system, e.g. via a switching element. The line connection can be switchable, in order to permit the selective or appropriate connection or isolation of line connection sections. Alternatively or additionally, inductive energy can also be routed to the consumer system or to at least one of the consumer units, which is introduced by a corresponding arrangement of the power supply system or of at least one power supply unit which is configurable for this purpose, or indirectly via further transmission means.

In one configuration, the power supply system comprises at least one primary power supply system having at least one primary power supply unit, and at least one secondary power supply system having at least one secondary power supply unit, wherein each of the at least two consumer units can be supplied with power by means of the at least one primary power supply system and the at least one secondary power supply system.

The at least two consumer units can thus be supplied with power by means of both the at least one primary power supply system and by means of the at least one secondary power supply system. Accordingly, not only can the failure of one of the at least two consumer units be compensated with respect to an at least partially shared functional scope, but any failure of a primary power supply system can be compensated by a secondary power supply system, or vice versa. Operational driving safety can thus be further enhanced.

The at least one primary power supply system and the at least one secondary power supply system can be independent power supply system units. Accordingly, the terms “primary” and “secondary” do not necessarily express any prioritization of power supply systems, but can be employed solely for the purposes of distinction. Correspondingly, the at least one primary power supply system and the at least one secondary power supply system can assume essentially comparable power supply values, i.e. capacity or capacitance values.

Alternatively, however, the at least one primary power supply system can also be provided for the primary supply of power, whereas the at least one secondary power supply system functions as a reserve power supply system. The at least one primary power supply system thus constitutes a main power supply system having at least one main power supply unit, and the secondary power supply system constitutes a supplementary power supply system having at least one supplementary power supply unit. A supplementary power supply system of this type, or at least the at least one supplementary power supply unit is particularly provided by way of a redundant power supply system unit vis-à-vis the primary power supply system, or at least the at least one primary power supply unit. As a result, in the event of the failure of the primary power supply system or of the at least one primary power supply unit, a supply of power can be maintained for at least part of the functional scope, in particular the at least partially shared functional scope, of at least one of the at least two consumer units. However, the time period over which the supplementary power supply system or the at least one supplementary power supply unit can maintain a supply to at least one of the at least two consumer units may be limited, if the supplementary power supply system or the at least one supplementary power supply unit has a lower capacity, in comparison with the primary power supply system or with the at least one primary power supply unit. The supply of power to at least one of the least two consumer units, signifies that it is not necessary for power to be simultaneously supplied to both of the at least two consumer units at all times. On the grounds of the provision of an at least partially common functional scope, for reasons of redundancy, a simultaneous power supply of this type can be provided such that, in the event of the failure of one of the at least two consumer units, the at least partially shared functional scope can be maintained, with no delays, by the at least one other of the at least two consumer units.

A power supply system having at least one main power supply system by way of a primary power supply system, having at least one main power supply unit by way of a primary power supply unit, and at least one supplementary power supply system by way of a secondary power supply system, having at least one supplementary power supply unit by way of a secondary power supply unit, can be operated, for example, in the form of a redundant power management system. For example, the redundant power management system can be connected to a steering function system, a braking function system or a HAD function system, by way of a respective consumer system. The redundant power management system delivers a supply of power to the functional units, by way of consumer units. In the event of the failure of the primary power supply system, or of the at least one primary power supply unit, or in the event that the latter cannot deliver sufficient power, the at least one supplementary power supply system or the at least one supplementary power supply unit can be switched-in or, if possible, can assume the full supply of power, in place of the primary power supply system or the at least one primary power supply unit.

Alternatively, consumer units can also be supplied with power by the at least one secondary power supply system by design, i.e. not only in the event of the failure of the primary power supply system. The at least one secondary power supply system, in turn, can then be supplied with power by the primary power supply system, in order to compensate the consumption of the at least one secondary power supply system in accordance with the power which is delivered thereby.

According to one further development, the at least equivalent functional scope comprises all safety-related and safety-critical functions, or all safety-critical functions within the functional scope of the at least two consumer units.

Safety-related functions contribute to the operational safety of the vehicle. Accordingly, although they enhance the operational safety of the vehicle, the failure thereof does not render operation of the vehicle impossible. Conversely, safety-critical functions are essential to the operation of the vehicle, i.e. in the event of the failure thereof, operation of the vehicle must be suspended. The classification of functions as safety-related or safety-critical functions can be variable, for example according to an operating mode of the vehicle or a driving maneuver. For example, a driver assistance system, such as a distance measurement system, can be safety-critical in an autonomous driving mode of a vehicle whereas, upon the assumption of vehicle control by a driver, this system is only classified, if at all, as safety-related. A classification of functions as safety-related or safety-critical can also be dependent upon whether a specific function is substitutable by another function, which is available. If, for example, a steering function of a steering actuator of the vehicle can be at least partially substituted by a braking function, the steering function may be safety-related only, at least within a predefined range.

As the at least partially common functional scope of the at least two consumer units encompasses all safety-related and safety-critical functions, or at least all safety-critical functions, the risk of a total loss of these functions is minimized. Particularly in consideration of a potentially reduced availability of power, for example associated with the loss of a primary power supply system and the replacement thereof by a secondary power supply system having a lower quantity of power available for supply, operational driving safety can thus be maintained. If, in this case, operation is conducted with a common functional scope which is restricted to safety-related or safety-critical functions, power demand can be reduced, in comparison with the full scope of functions. Residual maneuverability of the vehicle can thus be extended.

In one configuration, the power supply system comprises at least two secondary power supply systems, each of which is configured for the supply of the same of the at least two consumer units, such that the at least two consumer units can be supplied with power by each of the at least two secondary power supply systems.

Accordingly, the at least two consumer units are secured against any power supply failure by at least two secondary power supply systems. In particular, a respective number of outputs on each of the at least two secondary power supply systems at least corresponds to the respective number of the at least two secondary power supply systems, in order to permit the supply thereof with power. Alternatively or additionally, a line connection for the supply of power to the at least two consumer units, which is connected or connectable to at least two secondary power supply systems, can also be subdivided into a number of links which at least corresponds to the respective number of the at least two consumer units, in order to permit the supply of power to the at least two consumer units.

In particular, the at least two consumer units can optionally be supplied with power by each of the at least two secondary power supply systems.

Accordingly, it is not absolutely necessary for the at least two consumer units to be simultaneously supplied with power by the at least two secondary power supply systems. However, this arrangement can be provided as an option, in order to increase the quantity of power which is available for supply. Alternatively, the at least two consumer units, by means of the selectable supply of power, can respectively be supplied with power by means of only one of the at least two secondary power supply systems. The supply of power to one of the at least two consumer units can thus be executed by means of one of the at least two power supply systems, whereas the other of the at least two consumer units is supplied with power by means of the other secondary power supply system. However, the at least two consumer units can also be connected to the same secondary power supply system. In a further alternative, it is also possible for only one of the at least two consumer units to be supplied with power by only one of the at least two secondary power supply systems, whereas the other of the at least two consumer units is supplied by both or all of the at least two secondary power supply systems.

The selective supply of power to each of the at least two consumer units by means of one and/or other of the at least two secondary power supply systems can be executed by a corresponding activation or deactivation of the at least two secondary power supply systems or corresponding secondary power supply units and/or by the actuation of switches for the connection and isolations of link sections of the line connection to/from the power supply. The actuation of switches, for example, can be executed actively by means of a control device. Alternatively or additionally, however, passive switching elements can also be employed, which at least execute an interruption of the connection, for example in the event of an overload.

According to one configuration, the at least one power supply unit is connected or connectable to one or more outputs of the power supply system for the supply of power. In particular, the at least one secondary power supply unit is connected or connectable to one or more outputs of the secondary power supply system for the supply of power.

The power supply system can thus comprise a number of power supply units which at least corresponds to the number of outputs for the supply of power. Redundancy and flexibility of the power supply management system can be enhanced accordingly. However, the number of outputs for the supply of power can also be greater than the number of power supply units. Accordingly, for example in the event of the failure of a power supply output, at least partial redundancy can be provided. Alternatively, however, the number of power supply units can also be lower than the number of outputs on the power system, wherein the power supply units or, optionally, only a single power supply unit can then be switched to various outputs, as required. However, it is also possible for a plurality of power supply units to be switched to a common output.

Flexibility of design which is achievable, according to the configuration employed, in the interests of various optimization targets, such as greater redundancy or savings in weight or space, is particularly advantageous in the case of secondary power supply systems having secondary power supply units, as secondary power supply systems are generally only capable of delivering a comparatively limited quantity of power.

In particular, consumer units can be supplied with power from the primary power supply system and the secondary power supply system via at least one line connection. Each of the consumer units is thus connectable via at least one consumer switch and/or via at least one fuse to the line connection for the supply of power by the primary power supply system and the secondary power supply system, and is isolatable from the line connection.

Thus, by means of the at least one consumer switch, the at least two consumer units are simultaneously isolatable from, or connectable to a power supply from the primary power supply system and the secondary power supply system. In the event of a malfunction on at least one of the at least two consumer units which are supplied by the primary power supply system and/or the secondary power supply system, having potentially adverse influences upon other respective components of the power supply management system, any corresponding adverse influence can be prevented by means of isolation. For example, a line connection can be provided, via which the at least two consumer units can be supplied with power by the primary power supply system and the secondary power supply system. In the direction of the power flux, the line connection, down-circuit of the primary power supply system and the secondary power supply system divides into two line links. By means of one line link, one of the at least two consumer units is connectable to the primary power supply system and the secondary power supply system for the supply of power, and the other of the at least two consumer units is connectable by means of the other line link to primary power supply system and the secondary power supply system. A corresponding consumer switch can thus be arranged in the direction of the power flux, down-circuit of the primary power supply system and the secondary power supply system, and ahead of the line links to the at least two consumer units. Consequently, the at least two consumer units, by means of a common consumer switch, are connectable to and isolatable from the primary power supply system and the secondary power supply system via the line connection. Alternatively or additionally, one connecting switch can be provided for each line link, in order to permit the selective isolation of the at least two consumer units from, or the connection thereof to the line connection to the primary power supply system and the secondary power supply system.

Alternatively, or additionally, fuses can also be employed which, in the event of an overload, can at least interrupt a corresponding connection. If at least one fuse is employed in addition to a consumer switch, the response range of the at least one fuse, i.e. the load rating for the rupture of the fuse, can be set such that the response range of the fuse lies above a response range of the corresponding consumer switch. Accordingly, any potential interruption can preferably be executed by means of the consumer switch, such that the fuse is only engaged in the event of the failure of the latter. Connectivity of the load via the fuse is provided such that power flows through the fuse, which can thus form part of a connection. In the context of the consumer switch, the fuse can also be described as a consumer fuse.

In one configuration, the consumer units can be supplied with power from the primary power supply system and the secondary power supply system via at least one line connection. The at least one secondary power supply system is connectable to the line connection for the supply of power to the consumer units by means of at least one secondary power supply switch and/or at least one fuse, and is isolatable from the line connection. Alternatively or additionally, the at least one secondary power supply unit is connectable to the line connection for the supply of power to the consumer units by means of the at least one secondary power supply switch and/or at least one fuse, and is isolatable from the line connection.

The secondary power connecting switch can thus isolate the at least one secondary power supply system from the connecting line, with no resulting influence upon the supply of power to the at least two consumer units by the primary power supply system. If the secondary power connecting switch is not associated with the secondary power supply system as a whole, but is associated with at least one secondary power supply unit, isolation of this at least one secondary power supply unit can be executed without interrupting the supply of power to the at least two consumer units by means of the remaining secondary power supply units of the at least one secondary power supply system. Conversely, flexible connectivity of the at least one secondary power supply unit, in the event of multiple secondary power supply units on the at least one secondary power supply system, permits a supply of power in accordance with requirements. Here again, in a comparable manner to consumer switches, fuses can also be alternatively or additionally employed. In the context of the secondary power supply switch, the fuse can also be described as a secondary power supply fuse.

In one configuration, the consumer units can be supplied with power from the primary power supply system and the secondary power supply system via at least one line connection. The at least one primary power supply system is connectable to the line connection for the supply of power to the consumer units by means of least one primary power supply switch and/or at least one fuse, and is isolatable from the line connection. Alternatively or additionally, the at least one primary power supply unit is connectable to the line connection for the supply of power to the consumer units by means of the at least one primary power supply switch and/or at least one fuse, and is isolatable from the line connection.

In its function, and with respect to potential configurations, the primary power supply switch corresponds to the above-mentioned secondary power supply switch, but is associated with the at least one primary power supply system or the at least one primary power supply unit. Correspondingly, the primary power connecting switch can thus interrupt the connection of the at least one primary power supply system to the connecting line, with no resulting influence upon the supply of power to the at least two consumer units by the secondary power supply system. If the primary power connecting switch is not associated with the primary power supply system as a whole, but is associated with at least one primary power supply unit, isolation of this at least one primary power supply unit can be executed without interrupting the supply of power to the at least two consumer units by means of the remaining primary power supply units of the at least one primary power supply system. Conversely, flexible connectivity of the at least one primary power supply unit, in the event of multiple primary power supply units on the at least one primary power supply system, permits a supply of power in accordance with requirements. Here again, in a comparable manner to consumer switches, fuses can also be alternatively or additionally employed. In the context of the primary power supply switch, the fuse can also be described as a primary power supply fuse.

The consumer switch, the primary power supply switch and/or the secondary power supply switch can be configured in the form of actuatable switches which, for example, are actively actuated by means of a control device. Alternatively or additionally, however, passive switching elements can also be employed, which at least execute an interruption in the connection, for example in the event of an overload. However, switches can also comprise a dedicated processor unit and/or sensor system, which permit the switches to detect status conditions on the power supply management system and to execute a corresponding switching process. In particular, switches can also be configured to execute a self-diagnosis function. If a functional fault on a switch is detected by this means, a corresponding information signal can be relayed, for example to a control device, and/or the switch can be switched to an open or closed position. Switching to an open or closed position can be executed in consideration of a risk assessment of the respective setting for the power supply management system. An assessment of this type can be adaptable, according to the mode of operation and the driving maneuver of the vehicle which is to be executed.

In particular, at least the at least one consumer switch is a normally closed (NC) switch.

In the resting state, i.e. in the absence of activation, a NC switch, also described as a break contact, closes a connection, thus permitting the supply or relaying of power. Only upon the activation of the NC switch is the switch opened and the connection interrupted accordingly. By the configuration of the at least one consumer switch as an NC switch, in a deactivated state of the consumer switch, a connection is thus provided with the at least one primary power supply system and with the at least one secondary power supply system, provided that this connection is not otherwise interrupted. Another interruption can be conditional, for example, upon the at least one primary power supply switch and/or secondary power supply switch. Consequently, in the event of the failure of the at least one consumer switch in the form of a NC switch, the risk of any unintentional interruption of the power supply can be reduced.

In one configuration, at least the at least one secondary power supply switch and/or the at least one primary power supply switch is/are configured as a normally open (NO) switch.

In the resting state, i.e. in the absence of activation, a NO switch, also described as a make contact, opens a connection, and thus interrupts the supply or relaying of power. Only upon the activation of the NO switch is the switch closed, and a connection formed accordingly. For the supply of power to the at least two consumer units, the at least one secondary power supply switch and/or the at least one primary power supply switch, in the form of a NO switch, is activated accordingly. Any unnecessary power consumption, or any overload, can thus be prevented in the event of the failure of the at least one secondary power supply switch and/or of the at least one primary power supply switch. However, in order to permit the maintenance of a power supply to the at least one consumer unit, even in the event of a failure of the at least one secondary power supply switch and of the at least one primary power supply switch, if both are present, the at least one secondary power supply switch can also be configured as a NC switch and the at least one primary power supply switch as a NO switch, or vice versa.

In particular, the at least one consumer switch is a low-side switch.

The at least one consumer switch, in the form of a low-side switch, is located on a down-circuit side of the consumer system, in relation to a power flux. As a result, the consumer switch can also assume the functionality of a primary power supply switch and a secondary power supply switch. As the control circuit of the consumer switch has a ground connection, switching of the consumer switch, as a low-side switch, is straightforward.

In one configuration, the at least one consumer switch, the at least one secondary power supply switch, the at least one primary power supply switch and/or at least one further supplementary consumer switch for the further connectivity of at least one supplementary consumer system which is to be supplied with power is/are configured in the form of a high-side switch.

The individual components of the power supply management system are thus directly isolatable from one another by means of their respective switches, such that no residual power reaches the at least two consumer units. By this arrangement, conversely, any negative influences of the consumer units upon the power supply systems, in an up-circuit direction in relation to the power flux, can also be prevented.

In addition to the employment of corresponding switches, protection of the respective components of the power supply management system can also be achieved by the spatial separation of components, particularly of the power supply systems. As a result, protection against single-point faults, also described as single points of failure, can be enhanced. Positioning of the respective components, or groups thereof, at different locations can reduce the probability that all the components will be simultaneously affected by local disturbances, such as rockfalls, the penetration of water, or collisions. For example, components of the power supply management system can be positioned on one side of the longitudinal axis of the vehicle, whereas other components ae positioned on the other side of the longitudinal axis of the vehicle. Alternatively or additionally, components of the power supply management system can be arranged in the front half of the vehicle, and other components can be arranged in the rear half of the vehicle.

According to one configuration, the power supply management system comprises a monitoring device, which is configured to monitor the functional status of the at least partially identical functional scope of the at least two consumer units.

The functional status of the at least partially identical functional scope of the at least two consumer units involves both the availability of individual functions and the characteristics thereof in relation to a predefined function. In other words, the functional status is based upon a comparison between a target functional scope and an actual functional scope. By reference to the monitoring function, for example, a failure, or at least an impairment of the functional scope of one of the at least one consumer units can be detected. The monitoring device can be part of the at least one consumer system, part of a power supply system which is connectable to the at least one consumer system or to the at least two consumer units, and/or a superordinate monitoring device. Alternatively or additionally, the monitoring device can also be integrated in the at least one consumer switch, in the at least one secondary power supply switch, in the at least one primary power supply switch and/or in the at least one further supplementary consumer switch, or a corresponding monitoring function can be configured by means thereof. The monitoring function, for example, can be sensor-based and/or can be based upon the verification of a functional response characteristic.

In particular, the power supply management system is configured, in the event of the detection by the monitoring device of an at least partial failure of the at least partially identical functional scope on the at least one consumer unit, to supply power to at least the other consumer unit by means of the power supply system, in particular the primary power supply system and the secondary power supply system, and/or to activate the at least partially common functional scope of at least the other consumer unit.

To this end, the monitoring device can execute corresponding actuation functions itself and/or can relay the result of monitoring to a further control device. Such a control device, in turn, in a comparable manner to the monitoring device, can be part of the at least one consumer system, part of a power supply system which is connectable to the at least one consumer system or to the at least two consumer units, and/or a superordinate monitoring device. Alternatively or additionally, the monitoring device can also be integrated in the at least one consumer switch, in the at least one secondary power supply switch, in the at least one primary power supply switch and/or in the at least one further supplementary consumer switch, or a corresponding monitoring function can be configured by means thereof.

The at least two consumer units, for example, can both be supplied with power in tandem, wherein only the at least partially common functional scope of one of the at least two consumer units is activated, i.e. is configured for execution. In the event of the detection of a failure or of an impaired availability of the activated functional scope of the at least one consumer unit, the at least partially common functional scope of the other of the at least two consumer units is activated. An activation of the at least partially common functional scope can be executed, for example, by means of an activation of the consumer unit per se, i.e. by a switch-in of the respective consumer unit, and/or an activation of the at least partially common functional scope in the form of a release for the actual execution of functions on the consumer unit which is already switched-in. It can also be provided that the consumer unit has been switched-in beforehand, and that activation is based upon the consideration of output variables on the consumer unit which were not considered previously, or which bore no fruit. By the supply of power to the at least two consumer units in tandem, for example, the at least partially common functional scope, in the event of the failure of one of the at least two consumer units, can be immediately retrieved by the other of the at least two consumer units. Additionally, by means of the supply of power in tandem, other functions can be executed independently by the at least two consumer units, other than those included in the at least partially common functional scope.

Additionally, in a further example, only one of the at least two consumer units is supplied with power by the at least one power supply system. The at least partially common functional scope of the other of the at least two consumer units is activated, but requires a power supply in order to undertake the actual execution of functions. The requisite power supply is then triggered in response to the detection of the at least partial failure of the at least partially common functional scope of the consumer unit which has initially been supplied with power.

Each of the at least two consumer units can also be activated simultaneously and supplied with power. Detection of a failure of the at least partially common functional scope of one of the at least two consumer units can then dictate the execution of a power supply check and/or the activation of the other of the least two consumer units, in order to ensure the supply of power to and/or activation of at least one of the at least two consumer units.

The power supply management system can moreover be configured, not only to secure the supply of power to and/or activation of at least one of the at least two consumer units, but also to isolate from the line connection or the power supply system and/or to deactivate the one of the at least two consumer units on which the at least partial failure of the at least partially common functional scope has been detected. As a result, any unnecessary power consumption or risk of damage can be reduced.

According to a further aspect, the present invention relates to a method for operating an above-mentioned power supply management system, comprising the following steps:
Supply of power to at least one of the at least two consumer units, by means of the power supply system,
Monitoring of the at least one consumer unit which is supplied with power for the availability of the at least partially identical functional scope of the at least two consumer units, and:
Supply of at least one other of the at least two consumer units with power by means of the power supply system in the event that, by reference to monitoring, a reduced availability or a loss of availability of the at least partially identical functional scope of the at least two consumer units is detected.

Reduced availability or the loss of availability of the at least partially identical functional scope of one of the at least two consumer units can be dictated, for example, by a defect in the consumer unit itself, a voltage surge or a short-circuit, or by an interruption in the power supply resulting, for example, from a cable failure or a detached connector. Given that, in the event of an interruption in the power supply, this interruption must not impact upon other consumer units in the same manner, the corresponding other consumer unit can assume the execution of functions associated with the at least partially identical functional scope.

Advantages of the method ensue in an analogous manner to the description of the power supply management system which corresponds thereto, and which is configured in accordance with the execution of the process steps. In particular, functionally formulated features of the corresponding power supply management system can be considered separately as features of the method.

According to a further aspect, the present invention also relates to a computer program product, having program code which is stored on a machine-readable medium, for executing the above-mentioned method.

By means thereof, vehicles can be retrofitted in a particularly simple manner.

The invention is described in greater detail hereinafter with reference to the attached FIGURE.

### BRIEF DESCRIPTION OF THE DRAWING

FIG. 1 is a schematic representation of a power supply management system according to an exemplary embodiment of the invention.

### DETAILED DESCRIPTION OF THE DRAWING

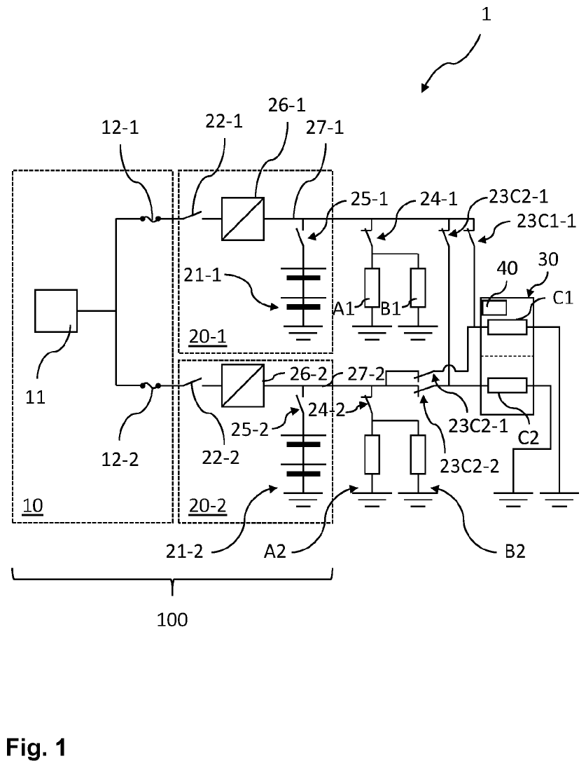

FIG. 1 shows a schematic representation of a power supply management system 1 according to an exemplary embodiment of the invention. The power supply management system 1 comprises a main power supply system by way of a primary power supply system 10, having a main power supply unit by way of a primary power supply unit 11, and two supplementary power systems by way of two secondary power supply systems 20-1, 20-2, each having a supplementary power supply unit by way of a respective secondary power supply unit 21-1, 21-2. The primary power supply system 10 and the two secondary power supply systems 20-1, 20-2 form a power supply system 100. The power supply management system 1 further comprises a consumer system 30 having two consumer units C1, C2. In the exemplary embodiment, the consumer units C1, C2 assume an identical functional scope. In alternative embodiments, however, the consumer units C1, C2 can also assume only a partially common functional scope.

For the supply of power to the consumer units C1, C2, a line connection 27-1 and a line connection 27-2 branch off from the power supply unit 11. Each of the line connections 27-1, 27-2 is connectable to each of the consumers C1, C2. To this end, the line connections 27-1, 27-2 branch into respective line links, the number of which corresponds to the number of consumer units C1, C2. To each consumer unit C1, C2, for each connecting line 27-1, 27-2, a consumer switch 23C1-1, 23C1-2, 23C2-1, 23C2-2, by means of which the respective connection to the respective line connections 27-1, 27-2 can be open and closed. The consumer switches 23C1-1, 23C1-2, 23C2-1, 23C2-2 are arranged between the power supply system 100 and the respective consumer unit C1, C2. The consumer switches 23C1-1, 23C1-2, 23C2-1, 23C2-2 are NC switches.

Moreover, by means of the line connection 27-1, further supplementary consumer systems A1, B1 and, by means of the line connection 27-2, further supplementary consumer systems A2, B2 can be supplied with power. The further supplementary consumer systems A1, B1, A2, B2, for the supply of power, can be connected via supplementary consumer switches 24-1, 24-2 to the respective line connection 27-1, 27-2, and isolated therefrom. The supplementary consumer switches 24-1, 24-2 are arranged between the power supply system 100 and the respective further supplementary consumer systems A1, B1, A2, B2. The supplementary consumer switches 24-1, 24-2 are configured as NC switches.

The consumer units C1, C2 can be selectively supplied with power by means of the primary power supply system 10 and/or by means of at least one of the secondary power supply systems 20-1, 20-2. By way of comparison, the supplementary consumer systems A1, B1, A2, B2, in the embodiment represented, can only be selectively supplied with power by means of the primary power supply system 10 and/or respectively by means of one of the second power supply systems 20-1, 20-2. In alternative embodiments, however, the supplementary consumer systems A1, B1, A2, B2, as per the consumer units C1, C2, can also be selectively supplied with power by means of the primary power supply system 10 and/or by means of at least one of the secondary power supply systems 20-1, 20-2.

For the potential supply of power to the consumer units C1, C2 and to the supplementary consumer units A1, B1 by the primary power supply system 10, the primary power supply unit 11 is connected via a primary power supply switch 22-1 to the line connection 27-1. The primary power supply switch 22-1 is configured as a NO switch, and is activated for the closure thereof, in order to supply power by means of the primary power supply unit 11 via the line connection 27-1. If the primary power supply switch 22-1 no longer opens, in the event of a malfunction, a fuse 12-1 is additionally provided between the primary power supply unit 11 and the primary power supply switch 22-1. The fuse is configured such that it will only respond within a range which lies above the response range of the primary power supply switch 22-1 and, accordingly, will only execute an interruption of the connection in the event of the failure of the latter. In an alternative embodiment, the fuse can also be arranged down-circuit of the primary power supply switch 22-1 in the direction of a power flux. The line connection 27-1 further comprises a converter 26-1 which is arranged down-circuit of the primary power supply switch 22-1, in the direction of the power flux, and which converts power from the primary supply unit 11 into power which will be routed to the consumers C1, C2 (by the conversion of voltage or current). In alternative embodiments, however, the converter 26-1 can also be positioned at another appropriate location, up-circuit of the consumer units C1, C2. For example, the converter 26-1 can also be arranged, in the direction of the power flux, down-circuit of both the primary power supply unit 11 and of the secondary power supply unit 21-1 which is connectable by means of a line connection 27-1. Accordingly, power which is supplied both by the primary power supply unit 11 and by the secondary power supply unit 21-1 can be converted by means of the converter 26-1.

For the potential supply of power to the consumer units C1, C2, and to the supplementary consumer units A1, B1, by the secondary power supply system 20-1, the secondary power supply unit 21-1 is connected via a secondary power supply switch 25-1 to the line connection 27-1. The secondary power supply switch 25-1 is configured as a NO switch and is activated, for the closure thereof, in order to supply power from the secondary power supply unit 21-1 via the line connection 27-1.

The potential supply of power to the consumer units C1, C2, and to the supplementary consumer systems A2, B2, by the primary power supply system 11 and the secondary power supply system 21-2 via the other line connection 27-2 proceeds in an analogous manner to the description of the supply of power via the line connection 27-1. The respective components for the potential supply of power via the other line connection 27-2 carry reference numbers in the x-2 series, rather than the x-1 series, for the purposes of distinction only.

In the normal operation of a vehicle, the consumer units C1 and C2 are supplied with power by the primary power supply system 10, such that both consumer units can execute the same functional scope. To this end, the primary power supply switches 22-1, 22-2 are closed, and the consumer switches 23C1-1, 23C1-2, 23C2-1, 23C2-2 are switched such that consumer unit C1, via the line connection 27-1, is supplied with power from the primary power supply system 10, and consumer unit C2, via the line connection 27-2, is supplied with power from the primary power supply system 10. In this case, the secondary power supply systems 21-1, 21-2 are not connected via the respective secondary power supply switches 25-1, 25-2 to the respective line connection 27-1, 27-2, and/or are deactivated.

In the event of the failure of the power supply system 10, no further power is supplied thereby, and the consumer units C1, C2 are supplied with power by the secondary power supply systems 20-1, 20-2. To this end, the respective secondary power supply switches 25-1, 25-2 are closed. The connection to the primary power supply system 10 or to the primary power supply unit 11 via the primary power supply switches 22-1, 22-2 or the fuses 12-1, 12-2 is interrupted and/or the primary power supply unit 11 is deactivated.

In this case, the consumer switches 23C1-1, 23C1-2, 23C2-1, 23C2-2 can maintain their switching states, as the supply of power to the consumer units C1, C2 continues to be executed via the line connections 27-1 and 27-2, and only a changeover of the corresponding power source (from the power supply system 10 to the secondary power supply systems 20-1, 20-2) has occurred.

In the event of the additional failure of one of the secondary power supply systems 20-1, 20-2, the consumer units C1, C2 can continue to be supplied with power by the other remaining power supply system 20-1, 20-2. To this end, only a corresponding changeover of the switching states of the consumer switches 23C1-1, 23C1-2, 23C2-1, 23C2-2 is required. If, for example, a supply of power to the consumer unit C1 via the line connection 27-1, i.e. by means of the secondary power supply system 20-1, is not possible, the switching states of the consumer switches 23C1-1, 23C1-2, 23C2-1, 23C2-2 are altered, such that the consumer unit C1 is connected to the line connection 27-2, and a supply of power to the consumer unit C1 by the secondary power supply system 20-2 can thus be executed via the line connection 27-2. Accordingly, both consumer units C1, C2 are then supplied by the secondary power supply system 20-2 via the line connection 27-2.

In the event that, conversely, a supply of power by the secondary power supply system 20-2 is no longer possible, the switching states of the consumer switches 23C1-1, 23C1-2, 23C2-1, 23C2-2 are altered, such that a supply of power to the consumer unit C2 can be executed by the secondary power supply system 20-1 via the line connection 27-1.

However, the power supply management system 1 is not only secured against a failure of a primary power supply system 10 and a secondary power supply system 20-1, 20-2, but is also secured against a failure of one of the consumer units C1 and C2, such that the functional capability of the consumer system 30, with respect to the common functional scope of the consumer units C1, C2 can be maintained. To this end, the functional status of common functions of the consumer units C1, C2 is monitored by a monitoring device 40. In an alternative embodiment, the at least two consumer units C1, C2 can also execute a reciprocal monitoring function. In the event of a reduction in the common functional scope of one of the consumer units C1, C2, the consumer switches 23C1-1, 23C1-2, 23C2-1, 23C2-2 associated therewith are isolated from any further supply of power, and the other consumer unit C1, C2 is maintained in service or activated and/or supplied with power. For example, in the event of the failure of consumer unit C1 on the grounds of a defect or an interruption in the power supply, the same functional scope can be executed by consumer unit C2. In this case, the switches 23C2-1 and 23C2-2 are closed.

In an alternative embodiment, it is also possible for only a partial scope of functions to be assumed by the other consumer unit C1, C2. If, for example, it is established by the monitoring device 40 and/or the consumer units C1, C2 that one or more functions of one consumer unit C1 is/are no longer available, these are then delivered by the other respective consumer unit C2. Monitoring can be executed, for example, by means of a plausibility check. In the event of implausible results for one consumer unit C1, C2, the execution of functions is then assumed by the other respective consumer unit C1, C2.

The invention is not limited to the embodiment described. Even in the event that, in the above-mentioned embodiment, the consumer units C1, C2 are supplied with power in normal operation by the primary power supply system 10, and the consumer units C1, C2 are only supplied with power by the secondary power supply systems 20-1, 20-2 upon the failure of the primary power supply system 10, the consumer units C1, C2, in normal operation, can also be supplied with power by the secondary power supply systems 20-1, 20-2. For example, the secondary power supply systems 20-1, 20-2 are then, in turn, supplied with power by the primary power supply system 10, in order to compensate the consumption of the secondary power supply systems 20-1, 20-2 in accordance with the power delivered thereby. Moreover, rather than the necessity for both consumer units C1, C2 to be supplied with power in tandem, it is possible for only one consumer unit C1, C2 to be supplied with power, pending the necessity for takeover by the other consumer unit C1, C2. In other words, it is possible for only the respective unit C1, C2 which is provided for the execution of functions to be supplied with power. Likewise, it is also possible for each of the consumer units C1, C2 to be simultaneously supplied with power by only one of the secondary power supply systems 20-1, 20-2. In this case, the other respective power supply system 20-1, 20-2 is only switched-in and/or activated in the event of the failure of the one secondary power supply system.

### LIST OF REFERENCE SYMBOLS

1 Power supply management system
10 Primary power supply system
11 Primary power supply unit
12-1, 12-2 Fuse
20-1, 20-2 Secondary power supply system
21-1, 21-2 Secondary power supply unit
22-1, 22-2 Primary power supply switch
23-1, 23-2 Consumer switch
24-1, 24-2 Supplementary consumer switch
25-1, 25-2 Secondary power supply switch
26-1, 26-2 Converter
27-1, 27-2 Line connection
30 Consumer system
40 Monitoring device
100 Power supply system
A1, A2, B1, B2 Supplementary consumer system
C1, C2 Consumer unit

1.-17. (canceled)

18. A power supply management system for a vehicle, comprising:
at least one power supply system having at least one power supply unit; and
at least one consumer system having at least two consumer units, each of which is able to be supplied with power by the power supply system,
wherein the at least two consumer units assume an at least partially identical functional scope.

19. The power supply management system according to claim 18, wherein the power supply system comprises:
at least one primary power supply system having at least one primary power supply unit, and
at least one secondary power supply system having at least one secondary power supply unit,
wherein each of the at least two consumer units is able to be supplied with power via the at least one primary power supply system and the at least one secondary power supply system.

20. The power supply management system according to claim 18, wherein
the at least partially identical functional scope comprises all safety-related and safety-critical functions, or all safety-critical functions within the functional scope of the at least two consumer units.

21. The power supply management system according to claim 19, wherein the power supply system comprises:
at least two secondary power supply systems, each of which is configured for supplying a same of the at least two consumer units, such that the at least two consumer units are able to be supplied with power by each of the at least two secondary power supply systems.

22. The power supply management system according to claim 21, wherein
the at least two consumer units are selectively supplied with power via each of the at least two secondary power supply systems.

23. The power supply management system according to claim 19, wherein
the at least one power supply unit is connected or connectable to one or more outputs of the power supply system for supply of power and,
the at least one secondary power supply unit is connected or connectable to one or more outputs of the secondary power supply system for supply of power.

24. The power supply management system according to claim 19, wherein
the at least two consumer units are supplied with power from the primary power supply system and the secondary power supply system via at least one connection line, and
each of the at least two consumer units is connectable to the connection line for the supply of power by the primary power supply system and the secondary power supply system via at least one consumer switch and/or at least one fuse, and is isolatable from the connection line.

25. The power supply management system according to claim 24, wherein
the at least two consumer units are supplied with power from the primary power supply system and the secondary power supply system via at least one connection line, and
the at least one secondary power supply system is connectable to the connection line for the supply of power to the at least two consumer units via at least one secondary power supply switch and/or at least one fuse, and is/are isolatable from the connection line.

26. The power supply management system according to claim 25, wherein
the at least two consumer units are supplied with power from the primary power supply system and the secondary power supply system via at least one connection line, and
the at least one primary power supply system and/or the at least one primary power supply unit is connectable to the connection line for the supply of power to the at least two consumer units via at least one primary power supply switch and/or at least one fuse, and is/are isolatable from the connection line.

27. The power supply management system according to claim 24, wherein at least the at least one consumer switch is a normally closed switch.

28. The power supply management system according to claim 25, wherein at least the at least one secondary power supply switch and/or at least one primary power supply switch is/are a normally open switch.

29. The power supply management system according to claim 26, wherein at least the at least one secondary power supply switch and/or at least one primary power supply switch is/are a normally open switch.

30. The power supply management system according to claim 24, wherein at least the at least one consumer switch is a low-side switch.

31. The power supply management system according to claim 26, wherein
the at least one consumer switch, the at least one secondary power supply switch, the at least one primary power supply switch, and/or at least one further supplementary consumer switch, for further connectivity of at least one supplementary consumer system which is to be supplied with power, is a high-side switch.

32. The power supply management system according to claim 19, wherein the power supply management system further comprises:
a monitoring device configured to monitor a functional status of the at least partially identical functional scope of the at least two consumer units.

33. The power supply management system according to claim 32, wherein
the power supply management system is configured, in an event of a detection by the monitoring device of an at least partial failure of the at least partially identical functional scope on the at least one consumer unit, to:
supply power to at least the other consumer unit via the primary power supply system and the secondary power supply system, and/or
activate the at least partially identical functional scope of at least the other consumer unit.

34. A method for operating a power supply management system, comprising:
supplying power to at least one of at least two consumer units, by way of a power supply system;
monitoring the at least one consumer unit which is supplied with power for availability of an at least partially identical functional scope of the at least two consumer units; and
supplying at least one other of the at least two consumer units with power by way of the power supply system in an event that, based on the monitoring, a reduced availability or a loss of availability of the at least partially identical functional scope of the at least two consumer units is detected.

35. A computer product comprising a non-transitory computer readable medium having stored thereon program code which, when executed by one or more processors, carries out the acts of:
supplying power to at least one of at least two consumer units, by way of a power supply system;
monitoring the at least one consumer unit which is supplied with power for availability of an at least partially identical functional scope of the at least two consumer units; and
supplying at least one other of the at least two consumer units with power by way of the power supply system in an event that, based on the monitoring, a reduced availability or a loss of availability of the at least partially identical functional scope of the at least two consumer units is detected.
